(19) United States
(12) Patent Application Publication
(10) Pub. No.: US 2007/0257553 A1
(43) Pub. Date: Nov. 8, 2007

(54) Method to Achieve Pressure Control Robustness in Brake Control Systems

(75) Inventor: John Joyce, West Bloomfield, MI (US)

Correspondence Address: Dickinson Wright PLLC, 38525 Woodward Avenue, Suite 2000, Bloomfield Hills, MI, 48304, US

(73) Assignee: Ford Global Technologies, LLC, Dearborn, MI (US)

(21) Appl. No.: 11/381,166

(22) Filed: May 2, 2006

(51) Int. Cl. B60T 8/66

(52) U.S. Cl. 303/156

(57) ABSTRACT

A method to achieve pressure control in a hydraulic brake system includes commanding an initial pressure increase in a hydraulic brake based upon a target pressure and thereafter commanding a series of sequential pressure decreases and pressure increases. Accordingly, the compliance effect within the hydraulic brake is minimized.

### TECHNICAL FIELD

The present invention is related a control system for hydraulic brakes and more particularly directed to a method to achieve pressure control robustness in a brake control system.

### BACKGROUND

Brake controls typically use pressure control as part of antilock, traction and/or stability controls. The pressure control is achieved by distributing pressure to the brake actuators by controlling remote control valves that respond to control signals from the controller. A typical example of a hydraulic control system of this kind is given in U.S. Pat. No. 5,468,058. The accuracy of the pressure control is in part dependent upon the compliance within the brake control system, such as the compliance of the brake connected to the hydraulic and electronic controllers. This compliance is primarily governed by pressure versus volume relationship manifested within the brake hydraulic system, such as the brakes connected to the hydraulic/electronic control unit. Variation in the pressure versus volume relationship typically leads to errors in the pressure control, particularly seen in each brake's hydraulics in the braking system. This effect can be particularly significant on drum brakes where variation in self-adjustment mechanisms can lead to variation in the compensation required for brake wear, thereby strongly influencing the pressure versus volume relationship independently at each brake. The effects of errors in the pressure control algorithm can lead to degraded control as well as mistaken fault recognition by plausibility algorithms.

Representatively, FIG. 3 shows a graph 199 having responses to a representative command pressure for different brake compliances. The pressure control algorithm sends a command signal 200 to an inlet control valve in order to achieve a specified pressure. Likewise, the pressure control algorithm may send a command signal to an outlet control valve in order to achieve pressure release. The command signal 200, typically implemented by a on-off valve or solenoid valve, is of a pulse wave form having a representative duration of 70 milliseconds as determined by the pressure control algorithm to achieve an expected brake pressure. For a brake with low compliance, i.e., a stiff brake, the pressure achieved during the pulse duration resultantly is as commanded, i.e., 80 bar, by the control algorithm and is represented by a stiff pressure response curve 202. For a brake having higher compliance, i.e., a compliant brake, the pressure achieved during the pulse duration fails to achieve the target pressure of 40 bars as commanded by the control algorithm and is shown by a compliant pressure response curve 204 only achieving 27 bars during the 70 millisecond valve pulse. Therefore, a compliant brake can effect braking performance and lead to errors in the pressure control algorithm.

Therefore, there is a desire to lessen the effect of compliance upon pressure control.

### SUMMARY

Accordingly, a method to achieve pressure control robustness in a brake control system is provided. The method advantageously makes the accuracy of pressure control independent of the compliance characteristic of the brake, i.e., minimization of the pressure versus volume effect.

A method to achieve pressure control in a hydraulic brake system includes commanding an initial pressure increase in a hydraulic brake based upon a target pressure and thereafter commanding a series of sequential pressure decreases and pressure increases. Accordingly, the compliance effect within the hydraulic brake is minimized.

Other advantages and features of the present invention will become apparent when viewed in light of the detailed description of the preferred embodiment when taken in conjunction with the attached drawings and appended claims.

### BRIEF DESCRIPTION OF THE DRAWINGS

FIG. 1 shows a hydraulic brake system for use to advantage with an embodiment of the invention.

FIG. 2 shows schematically a solenoid-operated valve system for an automotive brake system with anti-lock brake capabilities in accordance with the embodiment of FIG. 1.

FIG. 3 shows a graph having responses to a representative command pressure for different brake compliances.

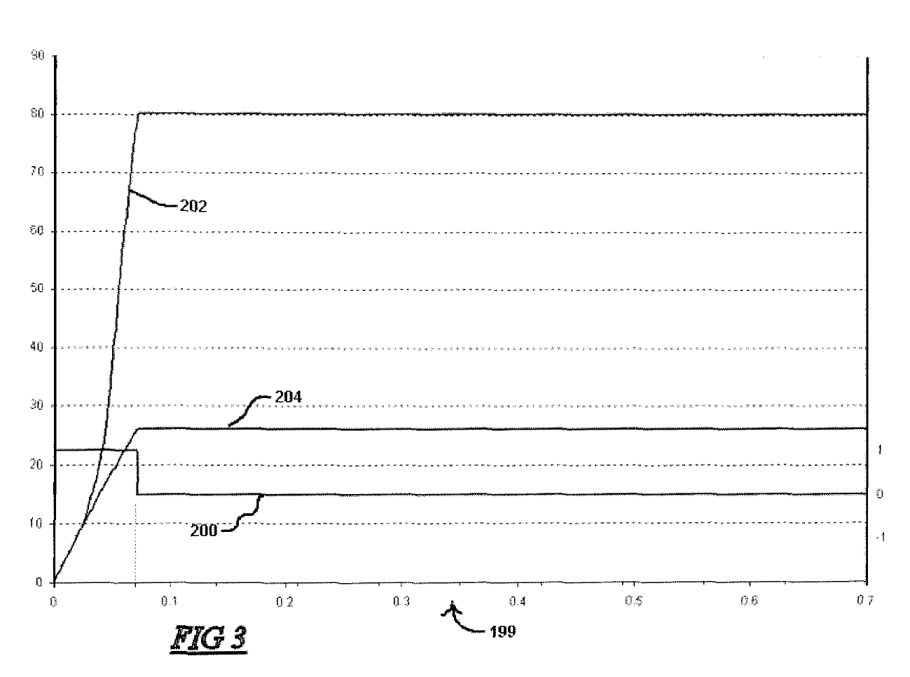

FIG. 4 shows a graph having responses to a representative command pressure for different brake compliances in accordance with a first embodiment of pressure control.

FIG. 5 shows a graph having responses to a representative command pressure for different brake compliances in accordance with a second embodiment of pressure control.

### DETAILED DESCRIPTION OF THE PREFERRED EMBODIMENT

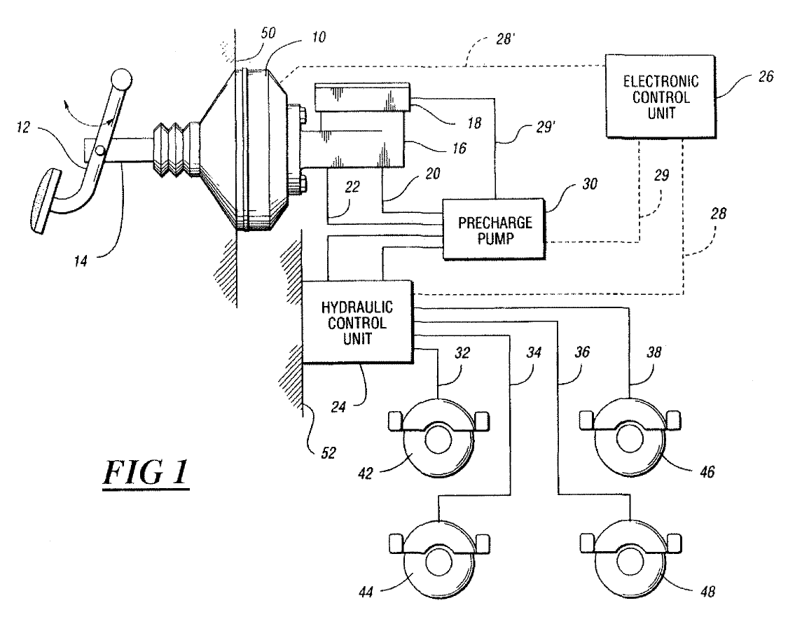

FIG. 1 shows a hydraulic brake system for use to advantage with an embodiment of the invention. The hydraulic brake system includes a brake actuator 10, a driver-operated brake pedal 12, and a mechanical linkage 14 that transfers motion of the brake pedal 14 to the brake actuator. The brake actuator may be of a conventional design, such as the brake booster and brake pedal arrangement shown in U.S. Pat. No. 5,551,770. Reference may be made to the '770 patent for the purposes of supplementing the present description. The disclosure of the '770 patent, as well as the disclosure of the '058 patent previously mentioned, is incorporated herein by reference. The hydraulic brake system is selected here as an example. The method here for robust pressure control may be used in a large number of systems influenced by the compliance effect in a corresponding hydraulic braking system. The pressure control can either be integrated in a hydraulic control unit 24 or embedded in an additional control unit or higher-level logic, such as an electronic control unit 26, the latter then being in communication with the hydraulic control unit 24. The pressure control influences the hydraulic brake system by decreasing the compliance effect in a hydraulic brake, thereby achieving improved stiffness and less compliances within the given brake. The method for robust pressure control is discussed below, but the brake system will first be discussed.

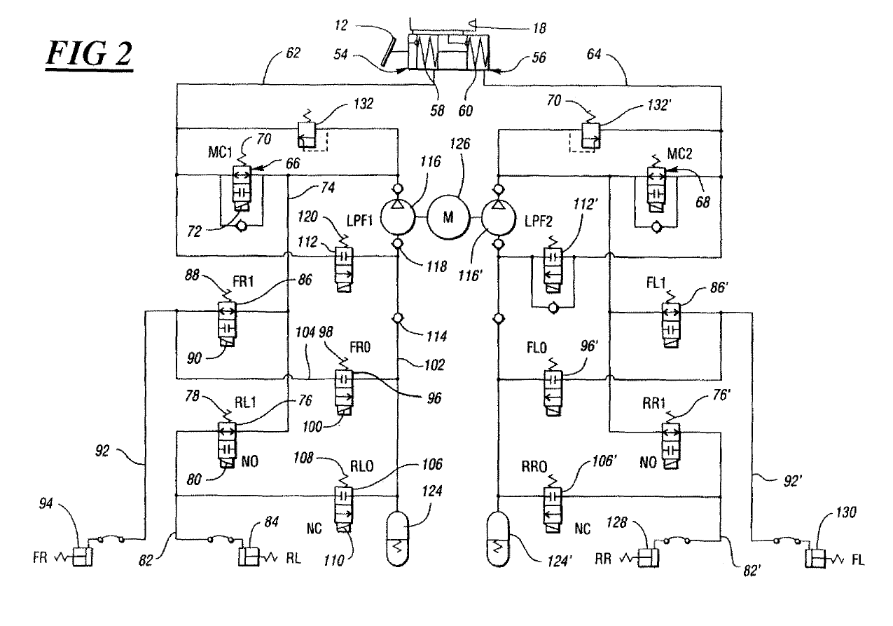

The brake system of FIG. 1 includes a master cylinder 16 on which is mounted a fluid reservoir 18. Hydraulic lines 20 and 22 connect the master cylinder to pre-charge pump 30, which in turn is connected by lines 20′ and 22′ to a hydraulic control unit 24. Hydraulic control unit 24 will be described with reference to the schematic diagram of FIG. 2.

An electronic control unit 26 is connected electronically through signal path 28 to the hydraulic control unit 24. It is connected also to actuator 10 through signal path 28′. Pre-charge pump 30 is connected to reservoir 18 through hydraulic line 29′.

In the system of FIG. 1, a pre-charge pump 30 is used to increase the charge pressure at the inlet side of the pump that forms a part of the control unit 24. The system for pressure control robustness, however, does not necessarily require a pre-charge pump. The use of a pre-charge pump is optional depending upon design considerations.

Hydraulic control lines 32, 34, 36 and 38 extend to right and left wheel brake actuators 42 and 44 and right and left rear brake actuators 46 and 48, respectively. The actuator 10 can be mounted on the vehicle body or chassis structure as indicated schematically at 50. Similarly, the hydraulic control unit can be mounted in known fashion on the vehicle chassis or suspension, as schematically illustrated at 52.

FIG. 2 shows schematically a solenoid-operated valve system for an automotive brake system with anti-lock brake capabilities. It includes a master cylinder having a first portion 54 for operating the front-right and rear-left wheel brakes and a second portion 56 for operating the right-rear and front-left wheel brakes. Master cylinder portions 54 and 56 correspond to the master cylinder 16 of FIG. 1.

When brake pedal 12 is actuated, springs 58 and 60 in the master cylinder portions are compressed, thereby displacing fluid into brake fluid conduits 62 and 64 as the brake piston in each master cylinder portion is moved.

A first master cylinder valve 66 is located in the brake fluid conduit 62 and a second master cylinder valve 68 is mounted in the brake fluid conduit 64.

Master cylinder valve 66 normally is open, which is the position shown in FIG. 2. It assumes the open position by reason of the force of valve spring 70. Valve 66 is solenoid operated, the solenoid being indicated at 72. When the solenoid 72 is energized, the master cylinder valve 66 is shifted to a closed position.

The outlet side of the valve 66 is connected to conduit 74 which extends to rear-left inlet valve 76, which normally is open. It is urged to its normally open position by valve spring 78. It includes a solenoid actuator 80 which, when energized, shifts the valve 76 to its closed position.

When the master cylinder portion 54 is pressurized by the operator, braking pressure is distributed through conduit 62, through valve 66, through conduit 74, through valve 76 and through conduit 82 to rear-left wheel brake 84.

A front-right inlet control valve 86 is normally open by reason of the action of valve spring 88. It includes a solenoid actuator 90 which, when energized, closes the valve 86. In the state shown in FIG. 2, valve 86 establishes communication between passage 74 and pressure conduit 92 extending to the front-right wheel brake 94.

A front-right outlet valve 96 is normally closed by reason of the action of valve spring 98, as seen in FIG. 2. Valve 96 includes a solenoid 100 which, when actuated, opens the valve 96, thereby establishing communication between low pressure feed passage 102 and passage 104, which extends to the conduit 92 for the front-right wheel brake 94.

A rear-left low pressure outlet valve 106 is normally closed. It is situated between conduit 102 and conduit 82 extending to the rear-left wheel brake 84. It is biased to its normally closed position by valve spring 108.

Valve 106 includes a solenoid 110 which, when energized, shifts the valve 106 to its open state, thus establishing communication between the low pressure conduit 102 and conduit 82. A low pressure feed valve 112 is situated between conduit 62 and low pressure feed conduit 102, the latter having a one-way flow valve 114 for permitting low pressure fluid flow toward the pump but preventing reverse flow, the pump being shown schematically at 116. A second one-way flow valve 118 is situated on the inlet side of the pump 116.

Valve 112 normally is closed by reason of the biasing action of valve spring 120. Valve 112 includes a solenoid 122 which, when actuated, shifts the valve 112 to its open state.

Low pressure feed passage 102 communicates with a fluid accumulator 124 for the purpose of supplying make-up fluid to the brake system.

Pump 116 is driven by an electric motor 126. A companion pump 116′ for the right rear brake 128 and the front-left brake 130 also is driven by the motor 126.

Pump 116′ forms a part of the control system that essentially is a duplicate of the control system for the rear-left brake 84 and the front-right brake 94. It contains solenoid-operated valves that are counterparts for the solenoid-operated valves for the brakes 84 and 94. They are designated by similar reference numerals, although prime notations are added.

During operation of the brake control system, the low pressure feed valves 112 and 112′ assume the positions shown. The electronic control unit 26, which receives wheel speed sensor signals, detects incipient slipping at the tire/road interface. If, for example, the front-right wheel begins to slip, the front-right flow control valve 96 is actuated, which opens passage 104 to low pressure feed passage 102. Simultaneously, the front-right inlet valve 86 is actuated, thereby blocking pressure distribution from conduit 74 to conduit 92. This results in an instantaneous decrease in the braking capacity of the front-right brake 94.

When the wheel speed sensors detect that incipient wheel slip no longer occurs, the electronic control unit will signal the valves 86 and 96 to resume their previous states. This again results in a pressure increase at the brake 94. The valves 86 and 96 are sequenced in this fashion during brake system control. However, while pressure increase or decreases at the brake 94 by activating valves 86 and 96, respectively, the compliance within the brake 94 may cause degraded control as well as mistaken fault recognition by plausibility algorithms. Accordingly, the pressure control is provided to increase the stiffness in the brake 94 and lessen its compliance effect, as described herein.

The pressure control valves for the other brakes function in a similar fashion. That is, the rear-left outlet valve 106 for brake 84 and the rear-left inlet valve 76 for brake 84 are sequenced by the electronic control unit 26 when incipient wheel slip is detected by the wheel speed sensor for the rear-left wheel. Minimizing the compliance effect by utilizing pressure control may also further increase the performance of each brake.

When brake control functions are not needed, the master control valve 66 again assumes the open position illustrated in FIG. 2. While, the above system has been described with respect to an automotive brake system with anti-lock brake capabilities, the pressure control to be described next may be used with other braking systems, such as a traction control system for example, without limitation.

A method for robust pressure control compensates for the error in the pressure control by alternating pressure increases and decreases in small amounts near the target pressure. By alternating pressure increases and decreases by utilizing the inlet control valve 86 and the outlet control valve 96, for example, the physics of hydraulic flow may be taken advantage of such that the error can be dramatically reduced in achieving the target pressure.

In general, for a given duration of a valve opening time, the fluid volume that flows through the valve is approximately proportional to the square-root of the pressure difference across the valve. Typically, for brake hydraulic systems, the valve has a constant orifice size and when fully open has a constant Cv, i.e., flow coefficient, in which the volume versus pressure relationship holds true. For example, activation of the inlet control valve 86 for a short duration lets fluid flow into the brake 94 that is initially at zero pressure; the volume of fluid that flows into the brake will be approximately the same regardless of the compliance characteristic of the brake, i.e., whether it is a stiff brake or a compliant brake, because of the volume versus pressure relationship. This is conventional pressure control. However, with the outlet control valve 96 closed, i.e., a constant volume system, as the fluid flows into the brake 94 the pressure builds differently in the compliant brake as compared to the stiff brake, thereby producing an error in target pressure. The pressure error in the brake develops because of volume versus pressure relationship of the brake, i.e., the compliant brake is demanding more fluid flow than the stiff brake to reach the same pressure. Therefore, since the hydraulic system parameters are the same for the stiff brake and the compliant brake, the compliant brake requires significantly longer activation time to reach the same target pressure as compared to the stiff brake because of the pressure versus volume fluid flow relationship. It is in this way that approximately the same fluid volume in the brake yields significantly different pressures depending on the volume versus pressure characteristic.

Given two different brakes A and B that are nearly identical in design but have different compliance rates when placed into service, if brake A is “stiffer” than brake B, then brake A will have a higher pressure than brake B for the same fluid flow through an inlet control valve. However, if the valve activation to increase pressure is followed by a subsequent command or series of commands that modulate the pressure the error is incrementally reduced. This occurs because of the basic physics of fluid flow. To understand, compare the effects of the sequence of activating the inlet and outlet control valves on brake A that is “stiffer” than brake B. After the initial activation of the inlet control valve to increase pressure, brake A has a higher pressure than brake B, as described above. If a subsequent activation of the outlet control valve to decrease pressure occurs, more fluid flows out of brake A than out of brake B because the pressure in brake A is higher and is governed by the fluid flow relationship. Accordingly, the pressure reduction in brake A is more than the pressure in brake B. The difference in pressures is now reduced. If pressure in brake A is still higher than brake B, and a subsequent activation of the inlet control valve is made to increase pressure, differentially less fluid flows into brake A because the pressure in brake A is higher, i.e., the pressure differential is smaller. After repeated valve activations the pressure in the brakes becomes nearly identical regardless of the pressure versus volume relationship or the compliance effect. The resultant pressure will only be a function of the flow characteristics of the valves and the comparative durations of the increase/decrease valve opening times. In this sense, if increase time is much longer than decrease time, the pressure will rise. Also, if increase time is much shorter than decrease time, the pressure will fall.

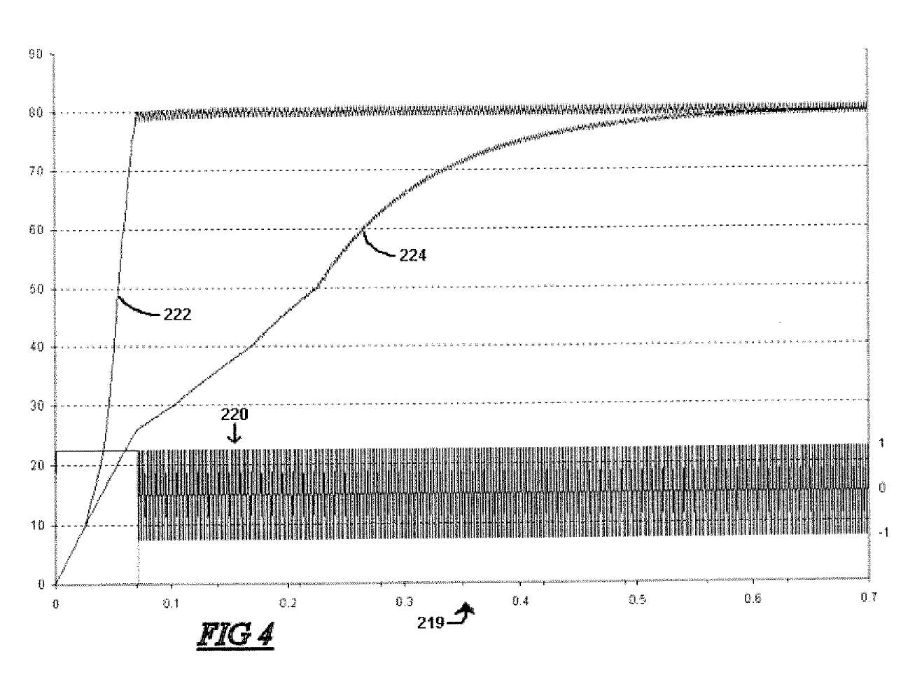

FIG. 4 shows a graph 219 having responses to a representative command pressure for different brake compliances in accordance with a first embodiment of pressure control. The pressure control algorithm sends a command signal 220 to an inlet control valve 86 in order to achieve a target pressure of 80 bars, for example. Likewise, the pressure control algorithm may send a command signal to an outlet control valve 96 in order to achieve pressure release. The inlet control valve 86 is represented as closed when the state is 0 or de-energized, and open when the state is 1 or energized, as is indicated on the right hand side axis of the graph 219. The outlet control valve 96 is represented as closed when the state is 0 or de-energized, and open when the state is −1 or energized, as is indicated on the right hand side axis of the graph 219. The command signal 220 provides initial pulse waveform to the inlet control valve 86 having a representative duration of 70 milliseconds as determined by the pressure control algorithm to achieve the initial expected pressure but, as mentioned above, the compliance within the brake causes error. Accordingly, after the initial pulse, the outlet control valve 96 is energized for 1 millisecond and then the inlet control valve 86 is again energized. By repeatedly changing the state of the inlet control valve 86 and the outlet control valve 96 the error is reduced and the target pressure is achieved in the brake 94. For a brake 94 with low compliance, i.e., a stiff brake, the pressure achieved and error reduction is quickly obtained by the repetitive activation of the valves 86, 96 as shown by stiff pressure response curve 222. For a brake having higher compliance, i.e. a compliant brake, the repetitive activation of the valves 86, 96 allows the target pressure is achieved as shown by compliant pressure response curve 224. Therefore, the error in a compliant brake can be minimized and lead to robust control. The pressure in the brake 94 is again returned to zero when there is no inlet supply pressure and the outlet control valve is commanded to bleed the pressure.

It is recognized that while the pressure control is accomplished by repeated activation of the inlet control valve 86 and the outlet control valve 96, the same pressure control may be accomplished by utilization of a valve or series of valves that are in fluid communication with the brake 94, thereby providing fluid control coming from at least a high pressure feed and a low pressure feed.

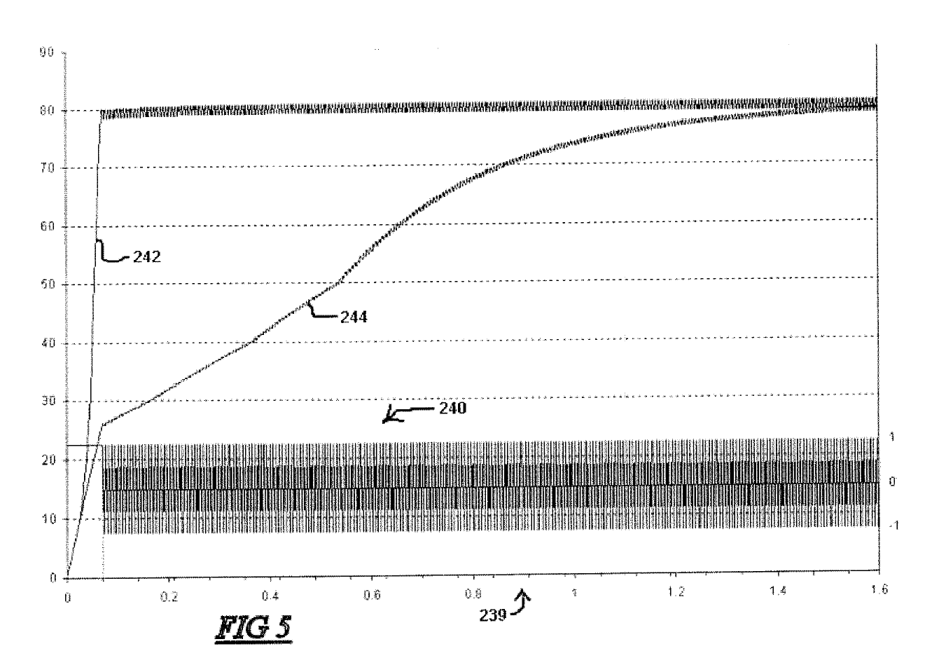

FIG. 5 shows a graph 239 having responses to a representative command pressure for different brake compliances in accordance with a second embodiment of pressure control. The pressure control may optionally be obtained by changing the frequency of pulse waveform for pressure increase time or for pressure decrease time as shown by pressure command 240. For example, after the initial activation of the inlet control valve 86 for 70 milliseconds, a varied activation time for the inlet control valve 86 of 1 millisecond is provided and the outlet control valve 96 having a 2 millisecond activation. By repeatedly changing the state of the inlet control valve 86 and the outlet control valve 96 the error is reduced and the target pressure is achieved in the brake 94. For a brake 94 with low compliance, i.e., a stiff brake, the pressure achieved and error reduction is quickly obtained by the varied activation of the valves 86, 96 as shown by stiff pressure response curve 242. For a brake having higher compliance, i.e., a compliant brake, the repetitive activation of the valves 86, 96 allows the target pressure is achieved as shown by compliant pressure response curve 244. Accordingly, allowing for varied or desired pressure control also facilitates achieving the target pressure and minimizing error. In this embodiment, pressure control is improved in a situation where flow supply is reduced.

Alternatively, the pressure control can be implemented by forcing the target pressure to oscillate.

It is recognized that with pressure control, the repeated increases and decreases in pressure will increase the total fluid flow used over any given period of time. However, it is very typical in control applications for there to be significantly more fluid flow available than is needed after the initial pressure control command of the hydraulic brake system. In this regard, the method for robust pressure control may be enhanced by modifying or alternating pressure increases/decreases based on the available fluid flow. For example, pressure control based upon available fluid flow may be accomplished by changing the amplitude or frequency of the valve activations based upon available fluid to achieve a constant or oscillating target pressure. Optionally, pressure control based upon available fluid flow could also be done directly on the valve opening time commands by placing a pressure hold command, i.e., a 0 state or de-energized state on the pressure inlet valve and on the pressure outlet valve, of varying length in between commands to increase/decrease pressure. In this respect, fluid flow is momentarily halted between commands. The duration of the pressure hold command would then be modulated depending on the available flow.

It is understood that the configuration of each control valve for increasing pressure or decreasing pressure will depend upon the particular system to which it is implemented. In this regard, when each valve is energized or de-energized it will have particular pressure logic. Also, the valve will have a logic also based upon whether it is a normally open valve or normally closed valve, as is understood by a person of skill in the art. Accordingly, while the particular embodiments are presented herein, it is to be understood that various valve combinations may be utilized to advantage in order to achieve pressure increases or pressure decreases as required to supply the commanded pressure to a brake.

While particular embodiments of the invention have been shown and described, numerous variations and alternate embodiments will occur to those skilled in the art. Accordingly, it is intended that the invention be limited only in terms of the appended claims.

What is claimed is:

1. A method to achieve pressure control in a hydraulic brake system comprising:
commanding an initial pressure increase in a hydraulic brake based upon a target pressure; and
commanding a series of sequential pressure decreases and pressure increases after said initial pressure increase,
wherein the compliance effect within said hydraulic brake is minimized.

2. The method of claim 1 wherein each of said series of sequential pressure decreases is for a constant time.

3. The method of claim 1 wherein each of said series of sequential pressure increases is for a constant time.

4. The method of claim 1 wherein each of said series of sequential pressure decreases and pressure increases are for a constant time.

5. The method of claim 1 further comprising commanding at least one pressure hold between subsequent pressure decreases or pressure increases.

6. The method of claim 5 wherein each of said at least one pressure hold is for a constant duration.

7. The method of claim 1 wherein said initial pressure increase and each subsequent pressure increase is controlled by either activating or deactivating a pressure inlet valve.

8. The method of claim 1 wherein each subsequent pressure decrease is controlled by either activating or deactivating a pressure outlet valve.

9. The method of claim 1 wherein said initial pressure increase, each subsequent pressure decreases, and each subsequent pressure increases are controlled by a single control valve.

10. The method of claim 1 wherein commanding said series of sequential pressure decreases and pressure increases is based upon assessing available fluid flow.

11. The method of claim 5 wherein commanding said at least one pressure hold is based upon assessing available fluid flow.

12. The method of claim 1 wherein said target pressure is commanded to oscillate.

13. A method of robust pressure control comprising:
activating an inlet control valve in response to achieving a target pressure for a finite duration;
deactivating said inlet control valve at the end of said finite duration; and
commanding, repetitively, activating and deactivating in sequence an outlet control valve and said inlet control valve,
wherein the pressure error for said target pressure is minimized in a hydraulic brake.

14. The method of claim 13 wherein said finite duration is determined for a stiff brake.

15. The method of claim 13 wherein said finite duration is substantially longer than said repetitive sequential activations and deactivation of said control valves.

16. The method of claim 13 wherein said finite duration is about 70 milliseconds.

17. The method of claim 13 wherein said repetitive activation and deactivation for said control valves is about 1 millisecond.

18. The method of claim 13 further comprising returning said control valves to an inactive state.

19. A method of pressure control comprising:
commanding an initial pressure in a hydraulic brake based upon a target pressure;
decreasing pressure in a hydraulic brake by activating a decreasing pressure control valve;
increasing pressure in said hydraulic brake by activating an increasing pressure control valve; and
repeating the steps of decreasing pressure and increasing pressure in said hydraulic brake,
wherein said target pressure error is minimized in said hydraulic brake.

20. The method of claim 19 further comprising holding pressure selectively between decreasing pressure or increasing pressure, wherein said target pressure error is minimized based upon available fluid.
